(19) United States
(12) Patent Application Publication
(10) Pub. No.: US 2024/0330718 A1
(43) Pub. Date: Oct. 3, 2024

(54) GENERATING KNOWLEDGE GRAPH DATABASES FOR ONLINE SYSTEM USING LARGE LANGUAGE MACHINE-LEARNED MODELS

(71) Applicant: Maplebear Inc., San Francisco, CA (US)

(72) Inventors: Li Tan, Fremont, CA (US); Tejaswi Tenneti, San Carlos, CA (US); Shishir Kumar Prasad, Fremont, CA (US); Huapu Pan, Scarsdale, NY (US); Taesik Na, Issaquah, WA (US); Tyler Russell Tate, Lexington, KY (US); Joshua Roberts, San Francisco, CA (US); Haixun Wang, Bellevue, WA (US)

(21) Appl. No.: 18/625,042

(22) Filed: Apr. 2, 2024

Related U.S. Application Data
(60) Provisional application No. 63/456,722, filed on Apr. 3, 2023.

(51) Int. Cl. G06N 5/022; G06F 16/901; G06F 40/205; G06F 40/40

(52) U.S. Cl. CPC G06N 5/022; G06F 16/9024; G06F 40/205; G06F 40/40

(57) ABSTRACT

An online system generates a knowledge graph database representing relationships between entities in the online system. The online system generates the knowledge graph database by at least obtaining descriptions for an item. The online system generates one or more prompts to a machine-learned language model, where a prompt includes a request to extract a set of attributes for the item from the description of the item. The online system receives a response generated from executing the machine-learned language model on the prompts. The online system parses the response to extract the set of attributes for the item. For each extracted attribute, the online system generates connections between an item node representing the item and a set of attribute nodes for the extracted set of attributes in the database.

### CROSS-REFERENCE TO RELATED APPLICATIONS

This application claims the benefit of U.S. Provisional Patent Application No. 63/456,722, filed on Apr. 3, 2023, which is incorporated herein in its entirety.

### BACKGROUND

An online system may store and manage information on many different types of entities. As an example, an online system may be a computing system by which users can order items to be fulfilled by a picker. A user of an online system browses through a catalog of available items. From the catalog of available items, the user provides an order to the online system. Therefore, the online system may store and manage information on entities such as users, items, attributes for the items, and the like. Typically, the information stored in a traditional database (e.g., row-based database) that may encode the complex relationships between these entities in a sparse data structure. It is difficult for the online system to gain insight and is computationally burdensome to identify relevant information as the online system may manage millions of items and attributes for those items.

### SUMMARY

In accordance with one or more aspects of the disclosure, an online system generates a knowledge graph database representing relationships between entities in the online system. The online system generates the knowledge graph database by at least obtaining descriptions for an item. The online system generates one or more prompts to a machine-learned language model, where a prompt includes a request to extract a set of attributes for the item from the description of the item. The online system receives a response generated from executing the machine-learned language model on the prompts. The online system parses the response to extract the set of attributes for the item. For each extracted attribute, the online system generates connections between an item node representing the item and a set of attribute nodes for the extracted set of attributes in the database.

The online system traverses the knowledge graph database to generate recommendations for the online system. Specifically, responsive to receiving an indication that a user accesses the online system (e.g., log in to a web or mobile application), the online system identifies one or more nodes in the knowledge graph database for the user. The online system traverses the knowledge graph database to identify one or more item nodes that are connected to the identified nodes. The online system presents items represented by the one or more item nodes as recommendations to the user.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates an example knowledge graph stored in a graph-based database, in accordance with one or more embodiments.

FIGS. 4A-4B is a flowchart for generating a knowledge graph database and traversing the database to generate recommendations, in accordance with one or more embodiments.

### DETAILED DESCRIPTION

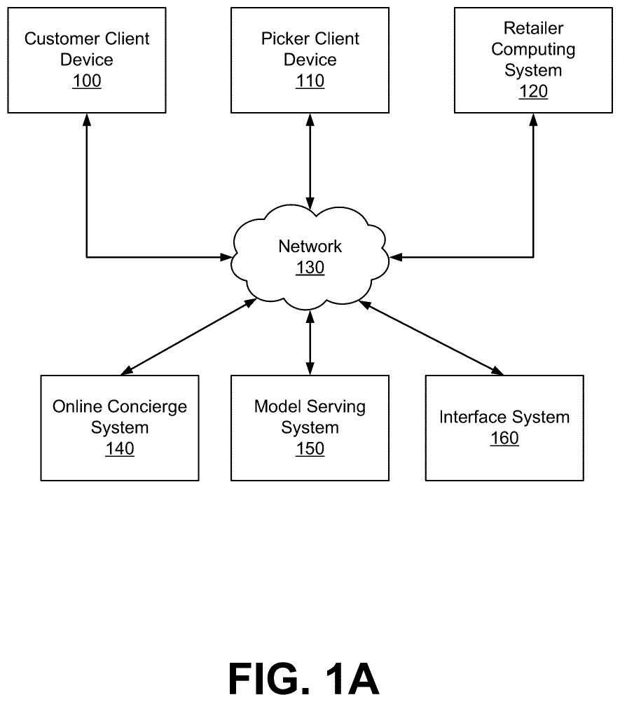

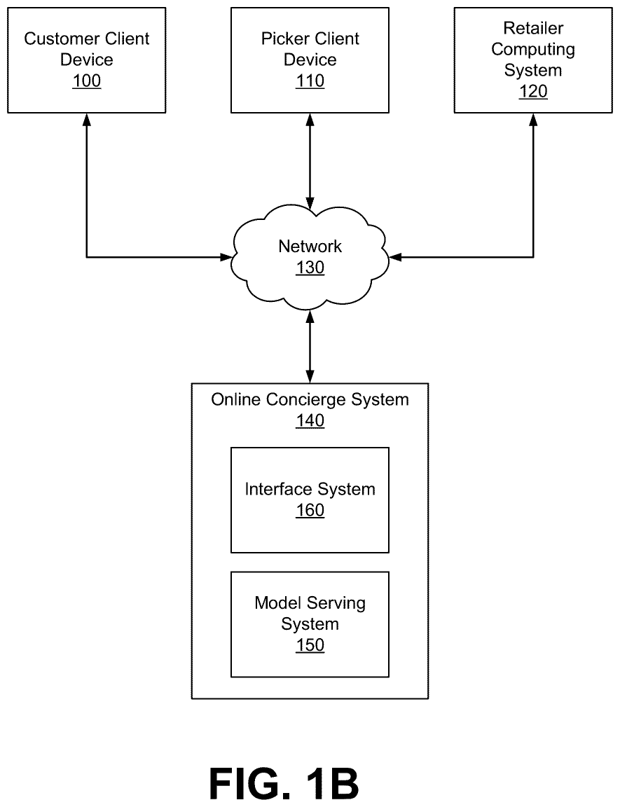

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

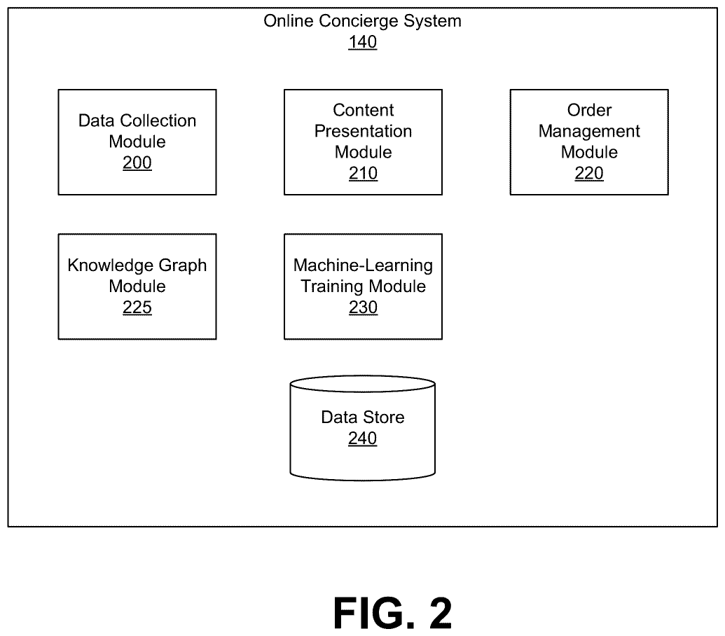

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the online system 140 performs an inference task in conjunction with the model serving system 150 or interface system 160 to generate a knowledge graph database that connects various entities within the online system 140 and represents relationships between those entities. The entities may include users (or segments of users), items, retailers, attributes related to the items, such as taxonomical concepts, cost, visual or taste characteristics, brands, health-related concepts, or tasks associated with the items. The knowledge graph database includes a set of nodes that each represent a respective entity. The knowledge graph database also includes one or more connections between nodes. A node connected to another node represents a relationship between respective entities represented by the nodes.

In one or more embodiments, the online system 140 constructs the relationships between entities by providing the model serving system 150 with a prompt that includes a request to identify entities related to an input entity. In one or more embodiments, the online system 140 obtains a description of an item, for example, instructions or labels (e.g., nutrition label) for the item from a retailer selling the item to extract a set of attributes for the item. The online system 140 constructs a prompt that includes at least the description for the item and a request to extract one or more attributes related to the item from the description. For example, a retailer may sell Fuji Apple items. The prompt may be executed on the model serving system 150 and a set of attributes “sweet,” “red fruit,” may be extracted from the response.

As described in more detail below, the online system 140 may create a node representing the item and one or more nodes for the extracted attributes in the knowledge graph database. The online system 140 creates one or more connections between the item node and the one or more attribute nodes. In addition to descriptions of items, the online system 140 may create other nodes and connections by prompting the large language model to infer relationships between different entities from the knowledge graph database.

In one or more embodiments, the online system 140 generates a graph embedding for each node that represents the respective entity in a latent space as a vector. The graph embedding for the entity incorporates information about how the node belongs to the structure of the knowledge graph in the context of other nodes connected to the node and the structure of the knowledge graph as a whole. In one or more embodiments, the graph embedding for a node may also incorporate semantic meaning (e.g., name of the entity for the node) in addition to the connections of the node in the knowledge graph.

After the knowledge graph database is constructed, the online system 140 may identify opportunities to traverse the knowledge graph and generate recommendations for a user. In one or more embodiments, the online system 140 may identify nodes that have embeddings numerically similar to embeddings for one or more input entities. The online system 140 may traverse the knowledge graph database to identify other nodes connected to the identified nodes. The online system 140 may generate recommendations for the user based on the identified nodes. As an example, for a user search query “gluten-free snacks,” the online system 140 identifies an attribute node representing a “gluten-free” concept and traverses connections to identify a set of item nodes connected to the gluten-free node. The identified items are presented to the user as a response to the search query.

By leveraging the deep knowledge of LLM's, the online system 140 constructs a knowledge graph database that models complex relationships between the many different entities of the online system 140. The knowledge graph provides in-depth insight into relationships between the different entities that are difficult to obtain. The knowledge graph database can also be used to generate more effective recommendations to users and due to the structure of the knowledge graph database, the response time for responding to a query may be significantly faster than a traditional database (e.g., row-based database).

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In one or more embodiments, given the content presentation module 210 receives one or more recommendations from the recommendation module 235 that were identified via a knowledge graph constructed by the knowledge graph module 225. The content presentation module 210 may present the items that were recommended by the recommendation module 235 to the user, such that the user can consider purchase of those items.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The knowledge graph module 225 constructs a graph depicting relationships between different entities of the online system 140 and traverses the generated knowledge graph database to perform one or more tasks (e.g., generate recommendations) for users. In one or more embodiments, the knowledge graph module 225 includes a plurality of nodes that each represent items, users, attributes related to items, and the like. In one instance, the attributes include taxonomical categories of an item (e.g., apples, fruits, plant-based foods), the brand for an item (e.g., “Fuji” for an apple), characteristics (e.g., sweet for Fuji apple), health-related attributes (e.g., gluten-free, organic, keto). Moreover, the knowledge graph database further includes one or more connections between nodes for which entities represented by the nodes have a relationship between each other.

In one or more embodiments, the knowledge graph module 225 generates the knowledge graph database by obtaining descriptions for an item. In one or more embodiments, the description for an item (e.g., Fuji apple for retailer with SKU 48309) is obtained from the retailer store, for example, from the label of the item, packaging from the item, or instructions for the item. For example, the description for the Fuji apple from the retailer store may include:

“One of the best apples, Fuji offers super crisp, sweet, and juicy
fruit with skin that ranges from yellow-green with red highlights to
mostly red. Exceptional for fresh eating. Stores well and is great for
baking. Ripens around fall. Plant a pollinizer such as Granny Smith,
Honeycrisp or Red Delicious. Great in apple pies!”

The knowledge graph module 225 generates one or more prompts for input to a machine-learned language model (deployed by the model serving system 150). The one or more prompts specify the description for the item and a request to extract a set of attributes for the item from the description of the item. The request may also specify instructions for the output to follow a schema. The schema may specify that the LLM extract attributes related to the brand of the item, generate ingredients related to the item, or generate health-related attributes for the item. For example, the prompt may be:

“An item has the following description: [example description above].
Extract attributes for the item from the description.The output
should follow schema listing attributes related to:
(1) brand of the item;
(2) other ingredients commonly used with the item;
(3) health-related concepts for the item;
(4) characteristics of the item; and
(5) taxonomical categories for the item.”

The knowledge graph module 225 receives, from the model serving system 150, a response generated by executing the machine-learned language model on the one or more prompts. The knowledge graph module 225 parses the response from the model serving system 150 to extract the set of attributes for the item. For example, the extracted attributes may be:

“(1) This item is associated with Fuji apples. (2) This item can be
combined with ingredients for pie crust to make apple pie. (3) This
item as a fruit is gluten-free. (4) This item has a high degree of
sweetness as a Fuji apple. (5) This item is a type of apple, which is
a type of fruit.”

Thus, the extracted attributes are “Fuji” as a brand, ingredients for pie crust as other ingredients that go with the item, gluten-free as a health-related concept for the item.

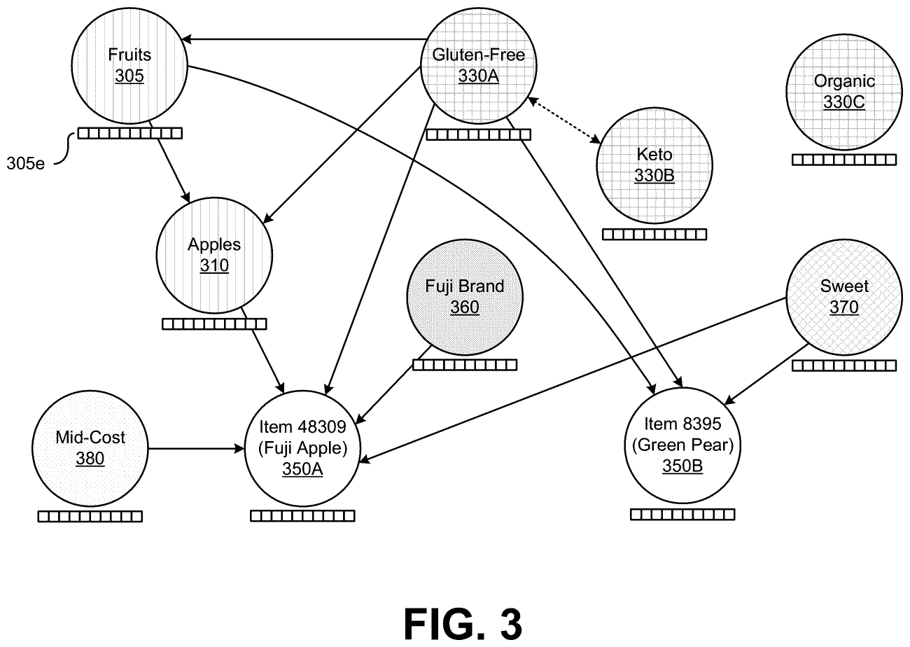

FIG. 3 illustrates an example knowledge graph stored in a knowledge graph database, in accordance with one or more embodiments. The knowledge graph module 225 generates nodes for the item and extracted attributes for the item in the knowledge graph database if nodes associated with these entities do not already exist. As shown in the example of FIG. 3, the item 48309 for a given retailer is given by node 350A. The nodes for the extracted attributes are generated or identified as example node 310 representing taxonomical category “apples”, node 305 representing taxonomical category “fruits,” node 360 representing “Fuji brand” of apples, node 330A representing health-related concept “gluten-free,” and node 370 representing the taste characteristic “sweet.” Thus, each node may be assigned to different attribute categories, as shown by the different fill patterns in FIG. 3.

The knowledge graph module 225 generates connections between the item node and attribute nodes representing the extracted attributes. As shown in the example of FIG. 3, connections are formed between the item node 350A and attribute nodes 305, 310, 330A, 360, 370. In one or more embodiments, a first node may have a connection to a second node of a certain degree that depends on the number of connections required to reach the second node. For example, the item node 350A is directly connected (or connected to a first degree) to the node 360, is connected to the second degree with node 305, and so on. Moreover, via other processes, the knowledge graph database may also include a node 350B representing a green pear item, a cost attribute node 380 representing mid-cost items, a node 330B representing health-related concept keto, and a node 330C representing health-related concept organic.

In one or more embodiments, the knowledge graph module 225 also extracts connections between nodes based on the general understanding of entities that are incorporated into the parameters of the large-language model or that are obtained from an external database (e.g., that the LLM summarizes). As an example, the knowledge graph module 225 may request the LLM to infer whether there are any connections between attribute nodes, such as nodes representing different health concepts, nodes representing different brands, and the like. As an example, the knowledge graph module 225 may prompt the LLM whether there are any relationships or connections between the health-related concepts keto, organic, and gluten-free represented by attribute nodes 330A, 330B, and 330C. Since the LLM may be trained on different sources of data, such as webpages, articles, dictionaries, and the like during training, the LLM may output connections between the nodes. As shown in FIG. 3, the knowledge graph module 225 may form a connection between the node 330A for gluten-free and the node 330B for keto as there is significant overlap between the two diets.

As yet another example, when the entities are common tasks performed by user segments, the knowledge graph module 225 can generate a prompt requesting common tasks that are performed for each user segment. An example prompt to the LLM of the model serving system 150 for a user segment of millennials may be:
“What tasks do Millennials use ABC Co. for?”
   The response from the LLM may be:

“Millennials use ABC Co. for a variety of tasks, including:
Grocery Shopping: ABC Co. is primarily used by millennials to buy
groceries online. This is a great time-saver for busy millennials.
Meal Planning: Many millennials use ABC Co. to plan meals for the week
ahead. They can easily select the ingredients they need for their
recipes and have them delivered to their doorstep.
Convenience: ABC Co. provides millennials with the convenience of
having groceries delivered right to their door. This is especially
useful for those who do not have access to transportation or have busy
schedules.
Special Occasions: Millennials also use ABC Co. for special occasions
like birthdays, anniversaries, and holidays. They can easily order
groceries and other party supplies online and have them delivered on
the same day.
Health Concerns: For millennials who are health-conscious, ABC Co.
offers a variety of options for organic, vegan, and gluten-free
products.”

The knowledge graph module 225 may receive the response and extract one or more common tasks for each user segment.

The knowledge graph module 225 parses responses from the model serving system 150 to extract the set of tasks performed by each user segment. As an example, the knowledge graph module 225 extracts tasks like “supporting a healthy diet” and “preventing aging.” Building on the example above, the knowledge graph module 225 may initiate nodes for the tasks of supporting a healthy diet and preventing aging. The knowledge graph module 225 connects the nodes to a related user segment via an edge.

As yet another example, the knowledge graph module 225 generates for each common task a prompt requesting item categories or brands that are used to satisfy the respective task. An example prompt to the LLM of the model serving system 150 for a task of making a healthy dinner may be:
“What items should one buy for a healthy dinner?”
   The response from the LLM may be:

“A healthy dinner should consist of a balance of nutrients including
protein, healthy fats, fiber-rich carbohydrates, and a variety of
vegetables. Here are some items that you can consider buying for a
healthy dinner:
Protein: Chicken breast, salmon, tofu, tempeh, lentils, black beans,
quinoa, and eggs
Carbohydrates: Sweet potatoes, brown rice, quinoa, whole-wheat pasta,
and whole-grain bread
Vegetables: Broccoli, kale, spinach, carrots, bell peppers, mushrooms,
and onions
Healthy fats: Avocado, nuts, seeds, olive oil, and coconut oil
Herbs and spices: Garlic, ginger, turmeric, cumin, paprika, and
oregano
Hydrate: remember to also drink plenty of water and avoid processed
foods as much as possible.”

The knowledge graph module 225 may receive the response and extract one or more item categories or brands for each task identified for a user segment. The knowledge graph module 225 may further initiate nodes for daily vitamins, protein supplements, collagen, and retinol. Connections between the task nodes and the item or brand nodes may be established via edges between the nodes.

In one or more embodiments, the knowledge graph module 225 trains a graph neural network (GNN) based on the constructed knowledge graph to generate graph embeddings for the entities. In one instance, the training process generates an embedding for each node in a set of nodes of the knowledge graph. The graph embedding for a node is a vector representation of the node in a latent space, and through the training process, the embedding incorporates information on how the concept represented by the node belongs within the structure of the knowledge graph, as well as additional information such as the semantic meaning of the node.

In one or more embodiments, the knowledge graph module 225 performs training by initializing values for the embeddings across nodes of the knowledge graph. For each iteration, the knowledge graph module 225 performs message passing where for each node, the knowledge graph module 225 identifies a set of neighbor nodes that have a connection (e.g., first degree connection) to the node. A set of intermediate embeddings are generated by applying a respective set of parameters (to be learned during the training process) to the embeddings for the node and the identified neighbor nodes. The embedding for the node is updated based on at least combining the set of intermediate embeddings.

A loss function is calculated based on the embedding values of the nodes. For example, the loss function may indicate a classification loss that indicates whether a classification estimate using the embedding for a node is likely correct or incorrect. As another example, the loss function may indicate a similarity between the embeddings of a pair of nodes that are known to be related (e.g., embeddings for a pair of item nodes, a pair of a node representing characteristics or an item and the node for the item). The knowledge graph module 225 updates parameters based on the loss function. This process is repeated for one or more iterations until a convergence criterion is reached.

In this manner, the embedding for a node will incorporate information from nodes that have a farther degree of connection as the training iterations are performed, and the embedding incorporates information about the structure of the knowledge graph database. Thus, nodes that have similar embeddings (e.g., distance between vector embeddings are below a threshold) are likely to share many connections with each other. As illustrated in FIG. 3, after the training process is completed, each node may be associated with an embedding vector. For example, the node 305 representing fruits is associated with embedding 305e. The constructed knowledge graph may be a superset of the item category information of the online system 140.

In one or more embodiments, the knowledge graph module 225 may receive requests for queries and obtain a response to the query by traversing the constructed knowledge graph database. Responsive to receiving a request, the knowledge graph module 225 identifies one or more relevant nodes in the knowledge graph database. The knowledge graph module 225 traverses the knowledge graph to identify one or more nodes connected to the identified nodes. The one or more nodes can be used to generate recommendations to the user.

For example, the knowledge graph module 225 may receive a query to generate a response to a user search query “gluten-free snacks.” The knowledge graph module 225 may identify node 330A representing the gluten-free concept as a relevant node and a node representing snacks as another relevant node. The knowledge graph module 225 traverses the knowledge graph to identify one or more nodes that are both connected to the relevant nodes. For example, these may include the item node 350A representing the Fuji apple item and another item node representing a plantain chips item. The knowledge graph module 225 presents recommendations for these items to the user, so that the user can add the items to the user's order.

As another example, the knowledge graph module 225 compares embedding values to generate recommendations. For example, a user may include a particular item in the user's order. The knowledge graph module 225 maps the item to a respective node in the knowledge graph database. The knowledge graph module 225 retrieves the embedding for the item node and compares the embedding value to embedding values for other neighboring nodes (e.g., nodes that are connected to second degree or less). The knowledge graph module 225 identifies a subset of nodes that have embeddings less than a predetermined threshold distance from the embedding of the item node. The knowledge graph module 225 may generate recommendations based on the identified subset of nodes.

For example, in the knowledge graph of FIG. 3, given that a user has the Fuji apple item in their order, the knowledge graph module 225 may determine that the embedding for the green pear item represented by node 350B has a similar embedding value (e.g., L2 norm of difference is less than a threshold) with the embedding for node 350A. The knowledge graph module 225 may generate a recommendation for the user to try the green pear item.

As yet another example, when the entities include tasks, the knowledge graph module 225 obtains information on a user and assigns the user to a user segment modeled by the knowledge graph. For example, the recommendation module 225 may obtain profile information (e.g., has two children) on the user from the data collection module 200, map the user to a particular user segment (e.g., user segment of parents). The knowledge graph module 225 may traverse the knowledge graph database to map the user to a user segment, identify tasks for the user segment, and identify items, item categories, or brands that map to the tasks.

As yet another example, when a user who is an elderly user accesses the application of the online system 140, the knowledge graph module 225 may traverse the knowledge graph database to identify the common tasks for a user segment of elderly users, identify the item categories or brands for each of the identified tasks, identify the items that match the respective categories or brands, and present the identified items to the user for recommendation. In one instance, the knowledge graph module 225 may present a suggested task to the user and for the suggested task, a list of items identified through the knowledge graph.

In one or more embodiments, the knowledge graph is stored as a network of entities and connections making up the relationships. As an example, the knowledge graph database may be stored as an array (e.g., two-dimensional array) or an array of lists on memory. The list for node i (e.g., arrayList[i]) may include a list of nodes that the node i is directly connected to. Compared to traditional row-based or column-based relational databases, graph-based databases can provide better performance and flexibility as they are more suited for modeling real-world scenarios.

Moreover, the knowledge graph module 225 may also leverage many traversal algorithms and machine-learning techniques to retrieve information from the knowledge graph that make it faster and computationally more efficient for retrieval compared to traditional databases. For example, the online system 140 may manage an inventory of millions of items, as well as attributes related to the items. One way to construct a database is to list the items as rows (e.g., millions of rows) and list the attributes as columns (e.g., millions of attributes), and indicate in the database which attributes are related to a respective item. The database may be relatively sparse. However, when a query is received, the online system 140 may have to search through the entire rows of the database, even though most entries are not relevant. Compared to traditional databases, the knowledge graph database described herein can leverage graph modeling techniques such as graph embeddings to retrieve relevant nodes, and thus, relevant items or attributes in a computationally efficient manner compared to conventional databases.

Moreover, while the specification describes a primary embodiment of the knowledge graph database in which the entities are user segments, tasks, taxonomical categories, characteristics, and the like, it is appreciated that in other embodiments the entities in the knowledge graph can be any appropriate entity affiliated with the online system 140 and the relationships may be modeled in other ways.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

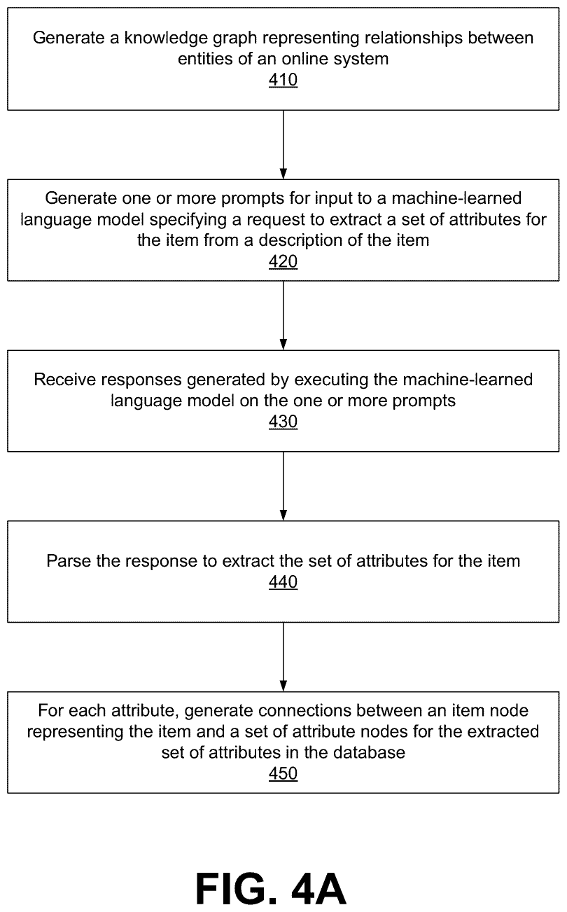

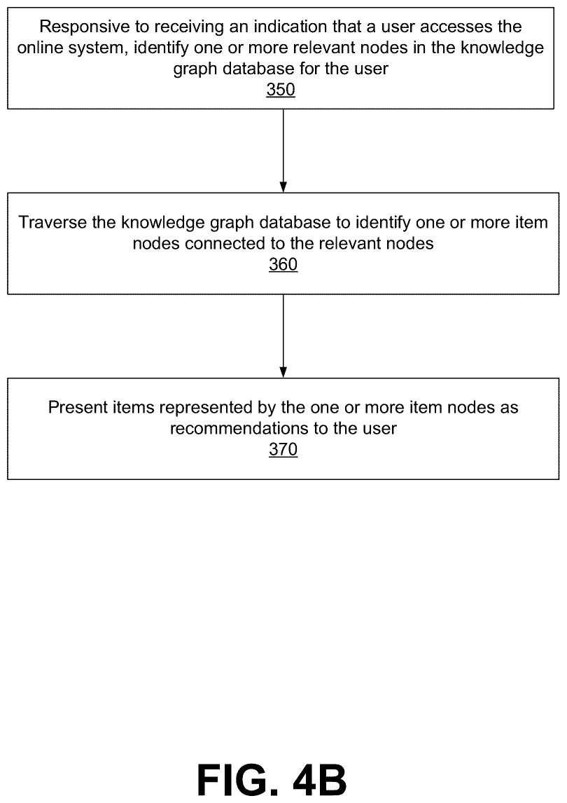

FIGS. 4A-4B is a flowchart for a method of generating a knowledge graph representing relationships between entities of an online system 140 and traversing the knowledge graph to generate recommendations, in accordance with one or more embodiments. The online system 140 generates 410 a knowledge graph database representing relationships between entities of an online system 140. Specifically, the online system 140 obtaining descriptions for an item. The online system 140 generates 420 one or more prompts for input to a machine-learned language model. The one or more prompts specify a request to extract a set of attributes for the item from the description of the item. The online system 140 receives 430, from a model serving system 150, responses generated by executing the machine-learned language model on the one or more prompts. The online system 140 parses 440 the response from the model serving system 150 to extract the set of attributes for the item. For each attribute, the online system 140 generates 450 connections between an item node representing the item and a set of attribute nodes for the extracted set of attributes in the database.

Responsive to receiving an indication that a user accesses the online system 140, the online system 140 identifies 350 one or more relevant nodes in the knowledge graph database for the user. The online system 140 traverses 360 the knowledge graph database to identify one or more item nodes connected to the relevant nodes. The online system 140 may then present 370 items represented by the one or more item nodes as recommendations to the user. Alternative embodiments may include more, fewer, or different steps from those illustrated in FIGS. 4A-4B and the steps may be performed in a different order from that illustrated in FIGS. 4A-4B. These steps may be performed by an online system (e.g., online system 140). Additionally, each of these steps may be performed automatically by the online system 140 without human intervention.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
generating a knowledge graph database representing relationships between entities of an online system, generating the knowledge graph database comprising:
obtaining descriptions for an item,
generating one or more prompts for input to a machine-learned language model, the one or more prompts specifying a request to extract a set of attributes for the item from the description of the item,
receiving, from a model serving system, responses generated by executing the machine-learned language model on the one or more prompts,
parsing the response from the model serving system to extract the set of attributes for the item, and
for each attribute, generating connections between an item node representing the item and a set of attribute nodes for the extracted set of attributes in the database;
responsive to receiving an indication that a user accesses the online system, identifying one or more relevant nodes in the knowledge graph database for the user;
traversing the knowledge graph database to identify one or more item nodes connected to the relevant nodes; and
presenting items represented by the one or more item nodes as recommendations to the user.

2. The method of claim 1, wherein extracting the set of attributes comprises extracting one or more of: a characteristic of the item, a health-related concept of the item, a brand of the item, or a taxonomical category of the item.

3. The method of claim 1, further comprising:
performing a training process to generate embeddings for the item node and the set of attribute nodes; and
responsive to receiving a second indication that a second user accesses the online system,
identifying a relevant node in the knowledge graph database for the second user,
identifying a subset of nodes having embeddings less than a threshold distance from an embedding of the relevant node, and
presenting items represented by the subset of nodes as recommendations to the second user.

4. The method of claim 3, wherein an embedding for a node incorporates semantic information for text describing the node.

5. The method of claim 3, wherein performing the training process further comprises:
for one or more iterations:
for a selected node, applying parameters to embeddings for the selected node and one or more neighbor nodes connected to the selected node to generate a set of intermediate embeddings;
combining the set of intermediate embeddings to generate an updated embedding for the node;
computing a loss function based on the updated embedding; and
backpropagating error terms from the loss function to update the parameters for a current iteration.

6. The method of claim 1, further comprising:
storing the knowledge graph database as an array of lists, wherein an element in the array represents a node and is associated with a list including neighbor nodes connected to the node.

7. The method of claim 1, wherein obtaining the descriptions for the item further comprises obtaining the descriptions from a label of the item or instructions for the item provided by a retailer of the item.

8. The method of claim 1, further comprising:
generating a second prompt for input to the machine-learned language model, the second prompt specifying another request to infer a connection between a first entity represented by a first node and a second entity represented by a second node in the knowledge graph database;
parsing the response from the model serving system to identify whether the connection exists between the first node and the second node; and
responsive to the identification, storing the connection between the first node and the second node in the graph knowledge database.

9. The method of claim 3, further comprising:
receiving feedback from the user on the presented items; and
performing a retraining process to update the embeddings for the item node and the set of attribute nodes.

10. A non-transitory computer readable storage medium comprising stored program code instructions, the instructions when executed causes a processing system to:
generate a knowledge graph database representing relationships between entities of an online system, generating the knowledge graph database comprising instructions when executed causing the processing system to:
obtain descriptions for an item,
generate one or more prompts for input to a machine-learned language model, the one or more prompts specifying a request to extract a set of attributes for the item from the description of the item,
receive, from a model serving system, responses generated by executing the machine-learned language model on the one or more prompts,
parse the response from the model serving system to extract the set of attributes for the item, and
for each attribute, generate connections between an item node representing the item and a set of attribute nodes for the extracted set of attributes in the database;
responsive to receiving an indication that a user accesses the online system, identify one or more relevant nodes in the knowledge graph database for the user;
traverse the knowledge graph database to identify one or more item nodes connected to the relevant nodes; and
present items represented by the one or more item nodes as recommendations to the user.

11. The non-transitory computer readable storage medium of claim 10, wherein extracting the set of attributes comprises extracting one or more of: a characteristic of the item, a health-related concept of the item, a brand of the item, or a taxonomical category of the item.

12. The non-transitory computer readable storage medium of claim 10, the instructions when executed further causes the processing system to:
perform a training process to generate embeddings for the item node and the set of attribute nodes; and
responsive to receiving a second indication that a second user accesses the online system,
identify a relevant node in the knowledge graph database for the second user,
identify a subset of nodes having embeddings less than a threshold distance from an embedding of the relevant node, and
present items represented by the subset of nodes as recommendations to the second user.

13. The non-transitory computer readable storage medium of claim 12, wherein an embedding for a node incorporates semantic information for text describing the node.

14. The non-transitory computer readable storage medium of claim 12, the instructions when executed further causes the processing system to:
for one or more iterations:
for a selected node, apply parameters to embeddings for the selected node and one or more neighbor nodes connected to the selected node to generate a set of intermediate embeddings;
combine the set of intermediate embeddings to generate an updated embedding for the node;
compute a loss function based on the updated embedding; and
backpropagate error terms from the loss function to update the parameters for a current iteration.

15. The non-transitory computer readable storage medium of claim 10, the instructions when executed further causes the processing system to:
store the knowledge graph database as an array of lists, wherein an element in the array represents a node and is associated with a list including neighbor nodes connected to the node.

16. The non-transitory computer readable storage medium of claim 10, the instructions when executed further causes the processing system to obtain the descriptions from a label of the item or instructions for the item provided by a retailer of the item.

17. The non-transitory computer readable storage medium of claim 10, the instructions when executed further causes the processing system to:
generate a second prompt for input to the machine-learned language model, the second prompt specifying another request to infer a connection between a first entity represented by a first node and a second entity represented by a second node in the knowledge graph database;
parse the response from the model serving system to identify whether the connection exists between the first node and the second node; and
responsive to the identification, store the connection between the first node and the second node in the graph knowledge database.

18. The non-transitory computer readable storage medium of claim 12, the instructions when executed further causes the processing system to:
receive feedback from the user on the presented items; and
perform a retraining process to update the embeddings for the item node and the set of attribute nodes.

19. A computer system comprising:
a processor; and
a non-transitory computer-readable medium storing instructions that, when executed by the processor, cause the processor to:
generate a knowledge graph database representing relationships between entities of an online system, generating the knowledge graph database comprising instructions when executed causing the processing system to:
obtain descriptions for an item,
generate one or more prompts for input to a machine-learned language model, the one or more prompts specifying a request to extract a set of attributes for the item from the description of the item,
receive, from a model serving system, responses generated by executing the machine-learned language model on the one or more prompts,
parse the response from the model serving system to extract the set of attributes for the item, and
for each attribute, generate connections between an item node representing the item and a set of attribute nodes for the extracted set of attributes in the database;
responsive to receiving an indication that a user accesses the online system, identify one or more relevant nodes in the knowledge graph database for the user;
traverse the knowledge graph database to identify one or more item nodes connected to the relevant nodes; and
present items represented by the one or more item nodes as recommendations to the user.

20. The computer system of claim 18, wherein the set of attributes includes one or a combination of a characteristic of the item, a health-related concept of the item, a brand of the item, and a taxonomical category of the item.
